(19) United States
(12) Patent Application Publication
(10) Pub. No.: US 2005/0023768 A1
(43) Pub. Date: Feb. 3, 2005

(54) Head gasket assembly

(76) Inventors: Jeffrey T. Adams, West Columbia, SC (US); Mark S. Whitlow, Columbia, SC (US); Ryan D. McCall, Lexington, SC (US); John S. Harr, Chapin, SC (US); Blake W. Liles, Columbia, SC (US)

Correspondence Address: John M. Harrington;Kilpatrick Stockton LLP, 1001 West Fourth Street, Winston-Salem, NC, 27101, US

(21) Appl. No.: 10/900,913

(22) Filed: Jul. 28, 2004

Related U.S. Application Data
(60) Provisional application No. 60/490,576, filed on Jul. 28, 2003.

(51) Int. Cl. F02F 11/00

(52) U.S. Cl. 277/592

(57) ABSTRACT

A head gasket assembly is provided comprising a solid non-compressible or rigid gasket body comprising a plurality of apertures for engine coolant, oil and combustion chambers. The gasket body has grooves formed therein for retaining and controlling the compression of elastomeric seals used for sealing engine coolant and oil apertures. The gasket body is then fitted or accompanied by a combustion seal. The combustion seals are specifically designed for the particular engine application, based on temperature, pressure and other operating characteristics. This assembly allows a direct fit with standard engine technology and requires no machining of heads, blocks, or cylinder liners. The result is a gasket body that precisely controls the compression on the seals, which improves engine performance without any machining of the engine while carrying highly elastic compounds to seal coolant and oil.

### CROSS REFERENCE TO RELATED APPLICATIONS

The present application claims priority under 35 U.S.C. § 119(e) from U.S. Provisional Patent Application Ser. No. 60/490,576 filed Jul. 28, 2003, entitled “Hybrid Head Gasket Assembly for High Performance Internal Combustion Engines”, the disclosure of which is incorporated herein by reference.

### FIELD OF THE INVENTION

The present invention relates to gaskets for use in high performance combustion applications. More particularly the present invention relates to head gaskets for internal combustion engines in high temperature and high pressure applications.

### BACKGROUND OF THE INVENTION

Current technology in head gaskets for high performance engines consists of compressible materials such as copper sheet, fibrous sheet, steel core graphite, and others; and non-compressible types such as steel shim gaskets, multi-layer steel gaskets, and others. An additional technology is a dry deck configuration.

Compressible sheet materials operate through deformation of the gasket material into surface imperfections of the cylinder head and engine block, thus creating a seal for coolant and oil locations.

These compressible sheet materials can employ a variety of technologies to seal the combustion chamber. One option is to wrap the fibrous material or graphite with steel on the inside diameter of the combustion opening of the gasket. This protects the gasket material from burning or erosion by the high temperatures and high pressures created during the combustion cycles of the engines. A variation on this method used to seal the combustion chamber is to insert solid steel wire or wires within the steel wrap to increase stress on the gasket section for better combustion sealing. A third method, primarily for sealing the combustion chamber with copper sheet gaskets, involves machining a groove in the engine block and/or the cylinder head which will receive a solid wire ring, increasing the stress around the cylinder bore.

Due to high contact stresses and/or high fastener preloads, these combustion chamber sealing technologies may cause increased cylinder bore distortion, which leads to decreased engine performance.

These particular compressible material technologies all rely on a deformable gasket body to seal coolant and oil locations. Although the deformable material can effectively seal the coolant and oil locations, the compression is typically controlled by the fastener preload and can result in an unknown compressed gasket thickness. This variable gasket thickness can result in inconsistent compression ratios, which decreases engine performance.

Additionally, these compressible materials can creep under load at elevated temperatures. To compensate for creep, the head studs may need to be retorqued. If the head studs are not retorqued, the cylinder head gasket may leak. If the head studs are retorqued, there is an increased likelihood of cylinder bore distortion, which will decrease engine performance.

These same compressible gasket materials also can be susceptible to chemical attack from coolant and oil additives commonly used by engine builders and/or race teams. The largest concern for sealing coolant and oil with these compressible gasket materials is that they do not offer a resilient seal area around coolant and oil locations, without which the gaskets are susceptible to leaking under head to block movements.

An alternate head gasket design employs non-compressible gaskets. One example of a non-compressible gasket is a multi-layer steel gasket. This type of gasket typically consists of multiple layers of thin steel, with the outside layers embossed and coated with a very thin layer of an elastomeric compound. However, the elastomeric compound may not have the necessary elastic recovery to effectively seal all high performance engines typically because the elastomer layers are too thin.

A common failure mode of multi layer steel gaskets is burning and erosion of the gasket between the cylinder bores. This can lead to cross over leakage, where gases from one cylinder escape to another and can even pressurize the coolant systems as the combustion gases push by the cylinder liners. These issues can decrease engine performance.

With recent advances in high performance engine building, the peak pressures, combustion temperatures and engine speeds, have all increased. The combination of these parameter increases can cause larger movements between the head and the block, thermal failure of gasket materials, pressure blow-out of the gasket, and fretting of gasket material surfaces. All of these phenomena contribute to decreased engine performance, possibly resulting in catastrophic engine failure.

The prior art head gasket technology's combustion sealing is done primarily with higher contact stress on the cylinder bores than anywhere else on the surface of the block. This stress causes deformation and distortion of the bore thus increasing blow-by, which is when combustion gases escape past the piston rings into the crankcase. This blow-by can be directly translated into horsepower loss.

A dry deck configuration requires discrete seal elements to be used to seal coolant and oil locations as well as the combustion chamber. These seal elements typically include rubber cords or rubber o-rings for the coolant and oil seal locations and individual metal combustion seals, such as Helicoflex tubular metal o-rings, Helicoflex pressure filled tubular metal o-rings, Helicoflex spring energized seals, Helicoflex spring energized c-rings, and Helicoflex c-rings, among others. The engine block (deck), the cylinder head, and/or the cylinder liner must be machined to receive said sealing elements. Although this sealing technology performs in an exceptional manner, this method can be very costly, thus limiting its use in the marketplace.

The present invention is directed toward a head gasket specifically designed for high temperature and high pressure applications where the compression of discrete coolant, oil, and combustion seals are specifically and accurately controlled. This provides a better seal, resulting in increased engine performance, with a longer useful life. Furthermore, machining of the head or block is not required, thus reducing the overall engine cost and enabling the product to have wider use in the marketplace.

Prior head gasket designs have not combined advantages of task specific seals which are designed for specific applications and integrated into one head gasket assembly. This head gasket assembly provides controlled compression of the seals and eliminates the need to machine the engine block, cylinder head, or cylinder liner.

It is to these perceived needs that the present invention is directed.

### SUMMARY OF THE INVENTION

In a first aspect of the present invention, a head gasket assembly is provided comprising, a gasket body comprising a first face and a second face defining a thickness therebetween, a plurality of apertures extending through the thickness of said gasket body, wherein at least one aperture comprises a combustion cylinder aperture and at least one aperture comprises a fluid aperture, said fluid aperture being surrounded on at least one face by a groove formed in the gasket body material, a fluid seal disposed within the groove surrounding the at least one fluid aperture, and a combustion seal associated with the combustion cylinder aperture.

In one embodiment of the present invention, the gasket body comprises one-piece construction, and is formed from a rigid or incompressible material, preferably a metallic material. The fluid aperture preferably has two grooves associated therewith, one on either face of the gasket body, and said grooves are preferably rectangular in cross section.

In another embodiment of the present invention, the fluid seal comprises a compressible or deformable material, preferably an elastomeric compound. The cross sectional area of the fluid seal is further preferably no greater than the cross sectional area of the groove in the gasket body.

In a still further embodiment of the present invention, the combustion seal comprises a metallic seal, preferably a spring-energized metallic seal. The head gasket assembly may further comprise a plurality of combustion cylinder apertures having a corresponding number of metallic combustion seals associated therewith. Similarly, the head gasket assembly may further comprise a plurality of fluid apertures each surrounded by a groove having a fluid seal disposed therein, and most preferably comprise two grooves surrounding each fluid aperture, each groove having a fluid seal disposed therein, the first groove on one side of the gasket body, and the second groove on the opposite side of the gasket body.

In an additional aspect of the present invention, a head gasket assembly is provided comprising, a gasket body comprising a first face and a second face defining a thickness therebetween, a plurality of apertures extending through the thickness of said gasket body, wherein at least one aperture comprises a combustion cylinder aperture and at least one aperture comprises a fluid aperture, said fluid aperture being surrounded on the first face and the second face by two grooves formed in the gasket body material, an elastomeric fluid seal disposed within said grooves surrounding the at least one fluid aperture, and a metallic combustion seal associated with the combustion cylinder aperture.

Features of a head gasket assembly of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

A head gasket assembly of the present invention provides numerous advantages over prior head gaskets and engine seals. For example, the present invention advantageously provides a head gasket assembly comprising individual seals designed for specific applications, such as oil, coolant, and combustion orifices, integrated into one head gasket which also provides controlled compression of the seals and eliminates the need to machine the head and/or gasket prior during installation.

As will be realized by those of skill in the art, many different embodiments of a head gasket assembly according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a partial perspective view of one face of a head gasket assembly according to an embodiment of the present invention.

FIG. 2 is an enlarged side view of a portion of the metallic combustion chamber seal in an embodiment of the present invention.

FIG. 3 is a schematic view of one embodiment of the present invention showing a cross section of a portion of the gasket body having a groove with an elastomeric seal positioned therein.

### DETAILED DESCRIPTION

The present invention relates to a head gasket assembly comprising a solid non-compressible or rigid gasket body comprising a plurality of apertures for engine coolant, oil and combustion chambers. The gasket body has grooves formed therein for retaining and controlling the compression of elastomeric seals used for sealing engine coolant and oil apertures. The gasket body is then fitted or accompanied by a combustion seal. The combustion seals are specifically designed for the particular engine application, based on temperature, pressure and other operating characteristics. This assembly allows a direct fit with standard engine technology and requires no machining of heads, blocks, or cylinder liners. The result is a gasket body that precisely controls the compression on the seals, which improves engine performance without any machining of the engine while carrying highly elastic compounds to seal coolant and oil.

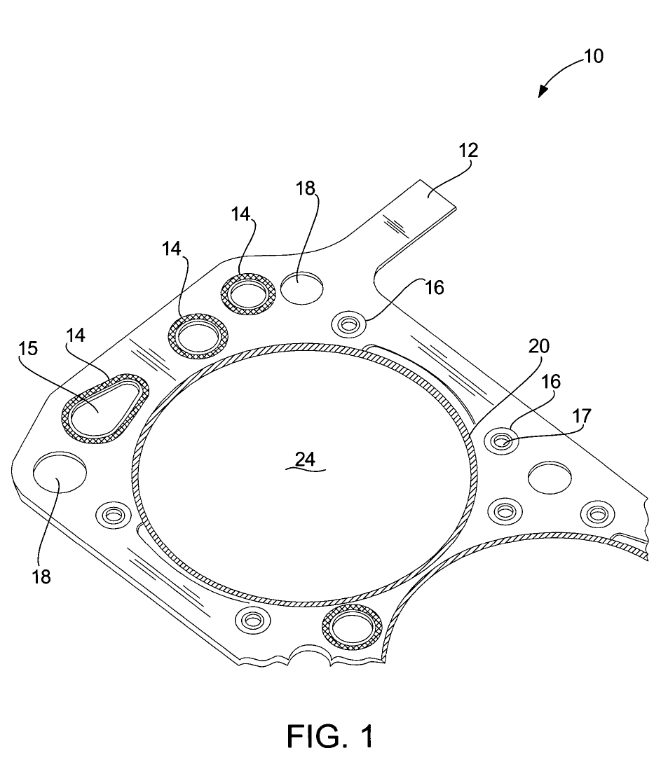

In one embodiment of the present invention, illustrated in FIG. 1 the gasket body 12 comprises a substantially flat plate having a plurality of apertures 15, 17, 18, 24 formed therein. These apertures include fastener holes 18, engine coolant apertures 17, engine oil apertures 15, and combustion cylinder apertures 24. The number and configuration of the various apertures will vary depending on the configuration of the engine in which the gasket assembly is to be used. Thus, in FIG. 1, only a portion of the gasket body 12 is shown to illustrate a configuration in an embodiment of the present invention.

The oil apertures 15, and coolant apertures 17, collectively the “fluid apertures” allow oil and coolant to pass from the engine block to the head. To prevent leakage of the oil and coolant, seals 14, 16 are provided surrounding each of the apertures. The present invention overcomes disadvantages seen in the prior art by providing grooves in the gasket body to retain the oil and coolant seals.

The combustion cylinder aperture 24 is surrounded by a metallic combustion seal 20 which is specially designed to withstand the extreme temperatures and pressures experienced within the cylinder.

In one embodiment of the present invention, the gasket body is constructed of a non-compressible, rigid material. The gasket body functions to align and retain the various seals during installation to control compression of the seals. Controlled compression of the seals is achieved by designing the seals 14, 16 and their respective grooves 13 such that the seal is compressed or deformed into the groove until the gasket face meets the engine block or cylinder head. The combustion seal is similarly designed so as to be compressed initially, until the gasket face meets the block and cylinder head at which point the compression is arrested by the non-compressible gasket body. Once the gasket face is in contact with both the engine block and head, the rigid, non-compressible gasket material will prevent further compression of the seals.

Therefore, the gasket body materials of one embodiment of the present invention must be sufficiently rigid to prevent over-compression of the seals. In a preferred embodiment of the present invention, the gasket body may comprise any metal or alloy like aluminum, copper, or steel. In another embodiment of the present invention, the gasket body is constructed from a carbon fiber based material. Further design characteristics such as heat transfer ability may also play a role in selection of the gasket body material.

In another embodiment of the present invention, the combustion chamber 24 is fitted preferably with a resilient metallic a combustion seal 20 designed specifically for the particular engine application conditions, which acts to prevent blow-out and improve the overall engine performance. These highly engineered combustion seals provide a level of sealing that exceeds current combustion sealing elements of traditional head gasket technology.

In a preferred embodiment of the present invention, the combustion seal is formed of a metallic material. A non-exclusive list of acceptable metallic combustion seals for use with the solid non-compressible gasket body includes: tubular metal o-ring, gas-filled tubular metal o-ring, low bore distortion spring energized seal, spring energized seal, metal c-ring, metal spring energized c-ring, or machined metal seal.

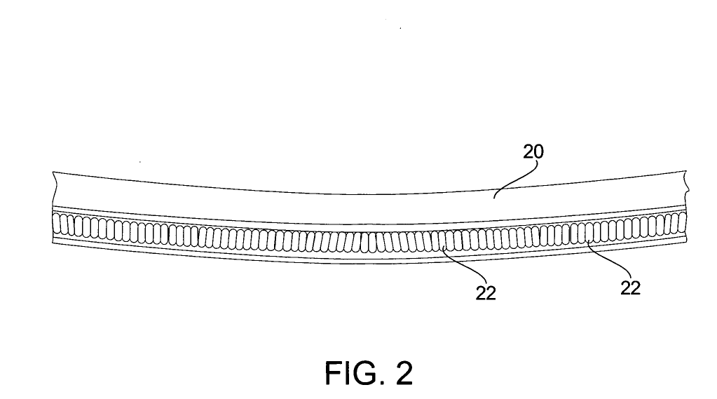

In a preferred embodiment of the present invention, the metallic combustion seal comprises a low bore distortion spring energized metal seal or “LDS”. This seal is illustrated in FIG. 2. The LDS comprises a coiled metal spring 22 surrounded by a metallic envelope or casing. The LDS produces less bore distortion and blow-by than other combustion seal products for high performance engines. In an additional embodiment of the present invention, the combustion seal comprises a metal hollow ring that can be self-energized by system pressure or pressure filled. A self-energized seal or spring-energized seal generally provides a more resilient sealing function and as such, is the preferred combustion seal for use in a preferred embodiment of the present invention.

All of these aforementioned sealing elements can be engineered to the specific pressure, temperatures, and head to block movements to optimize the sealing levels and minimize the distortion of the engine block, cylinder head, and especially the cylinder bore. This reduced distortion can decrease blow-by as well as improve the rigidity of the head to block interface.

The metallic combustion seals are then attached or laid into the gasket body. The metallic combustion seals may be affixed to the gasket body though an adhesive compound, such as adhesive RTV (room temperature vulcanizing), or mechanically, depending on the application. For example, such high performance head gaskets are used in conjunction with race vehicles and must adhere to race regulations regarding materials and construction.

Sealing compounds or elastomer seals/cords are bonded in the grooves 13 in the gasket body 12. A non-exclusive list of acceptable materials includes: two part liquid silicone rubbers, RTV silicones, Viton cords/o-rings, perfluoroelastomers, rubber, and other materials engineered for heat, pressure, and chemical additive resistance.

The elastomeric beaded compounds, cords, or molded rubber inserts create resilient seals that are superior to prior art head gasket seals. Further, by disposing the fluid seals within a groove in the gasket body the present invention effects a controlled compression of the seal not currently available from current head gasket technology for coolant and oil sealing. These compounds and cords create a highly effective controlled compression seal for oil and coolant. These seals have controlled compression designed to eliminate creep because of the rigid gasket body they are contained within thus minimizing fastener load loss due to gasket thinning.

In another embodiment of the present invention, compounds for coolant and oil sealing comprise sheet gasket materials cut to fit the grooves and disposed therein. These seals may be affixed within the grooves with adhesive, or press-fit.

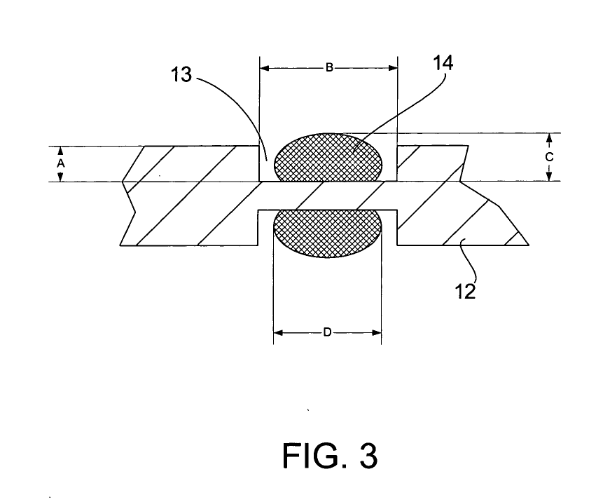

FIG. 3 illustrates a preferred embodiment of the present invention showing a cross section of the assembly with an elastomeric fluid seal in place in the gasket body. The groove 13 in the gasket body is preferably, but not exclusively, rectangular in cross section and comprises a height A and a width B. However, one skilled in the art will recognize other groove shapes are well within the scope of the present invention. For example, suitable shapes for the groove cross section include rectangular, rounded, oval, or trapezoidal.

Similarly, the seal 14 is shown having an oval shape comprising a height C and a width D. The height of the seal C is greater than the height of the groove A such that a portion of the seal extends from the top of the groove. The width of the seal D is less than the width of the groove B to provide area within the groove for the seal to compress or deform into during compression.

This arrangement allows the seal to protrude from the groove to provide a sealing engagement with the cylinder head on one side of the gasket and the engine block on the opposite side. As the fasteners are tightened, and the head and block compress the head gasket assembly, the seal 14 will be compressed and deform into this groove, thereby controlling the compressive force exerted on the seal. Once the head and block contact either side of the gasket, the gasket body material will prevent the seal from being further compressed.

In an alternate embodiment of the present invention, the grooves 13 are open to the apertures 15, 17 such that they form a counterbore along the perimeter of the aperture. In this embodiment the elastomeric seals are replaces with grommets which fit into the counterbores to provide a sealing function. In this manner, the groove and seal configuration is replaced with a counterbore and grommet assembly. Other variations on the sealing function of the present invention will be apparent to those of skill in the art.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A head gasket assembly comprising:
a gasket body comprising a first face and a second face defining a thickness therebetween;
a plurality of apertures extending through the thickness of said gasket body, wherein at least one aperture comprises a combustion cylinder aperture and at least one aperture comprises a fluid aperture, said fluid aperture being surrounded on at least one face by a groove formed in the gasket body material;
a fluid seal disposed within the groove surrounding the at least one fluid aperture; and,
a combustion seal associated with the combustion cylinder aperture.

2. The head gasket assembly of claim 1, wherein said gasket body material comprises a rigid material.

3. The head gasket assembly of claim 1, wherein said gasket body material comprises an incompressible material.

4. The head gasket assembly of claim 1, wherein said gasket body material comprises a metallic material.

5. The head gasket assembly of claim 1, wherein the fluid aperture has two grooves associated therewith, one groove on either face of the gasket and surrounding the associated aperture.

6. The head gasket assembly of claim 1, wherein said fluid seal comprises a compressible material.

7. The head gasket assembly of claim 1, wherein said fluid seal comprises a deformable material.

8. The head gasket assembly of claim 1, wherein said fluid seal comprises an elastomeric compound.

9. The head gasket assembly of claim 1, wherein the cross sectional height of the fluid seal is greater than the cross sectional depth of the groove in the gasket body.

10. The head gasket assembly of claim 1, wherein the combustion seal comprises a metallic seal.

11. The head gasket assembly of claim 1, wherein the combustion seal comprises a spring-energized seal.

12. The head gasket assembly of claim 1, wherein the combustion seal comprises a tubular metal o-ring.

13. The head gasket assembly of claim 1, wherein the combustion seal comprises a metal c-ring.

14. The head gasket assembly of claim 1, wherein the combustion seal comprises a machined metal seal.

15. The head gasket assembly of claim 1, wherein the combustion seal comprises a formed metal seal.

16. The head gasket assembly of claim 1, further comprising a plurality of combustion cylinder apertures having a corresponding number of metallic combustion seals associated therewith.

17. The head gasket assembly of claim 1, further comprising a plurality of fluid apertures each surrounded by a groove having a fluid seal disposed therein.

18. The head gasket assembly of claim 15, wherein each fluid aperture is surrounded by two grooves, each groove having a fluid seal disposed therein, the first groove on one side of the gasket body, and the second groove on the opposite side of the gasket body.

19. A head gasket assembly comprising:
a gasket body comprising a first face and a second face defining a thickness therebetween;
a plurality of apertures extending through the thickness of said gasket body, wherein at least one aperture comprises a combustion cylinder aperture and at least one aperture comprises a fluid aperture, said fluid aperture being surrounded on the first face and the second face by two grooves formed in the gasket body material;
an elastomeric fluid seal disposed within said grooves surrounding the at least one fluid aperture; and,
a metallic low distortion spring energized combustion seal associated with the combustion cylinder aperture.

20. A head gasket assembly comprising:
a gasket body comprising a first face and a second face defining a thickness therebetween;
a plurality of apertures extending through the thickness of said gasket body, wherein at least one aperture comprises a combustion cylinder aperture and at least one aperture comprises a fluid aperture, said fluid aperture further comprising a counterbore surrounding and open to the aperture on the first face of the gasket body;
an elastomeric grommet disposed within said counterbore surrounding the at least one fluid aperture; and,
a metallic combustion seal associated with the combustion cylinder aperture.
